(19) United States
(12) Patent Application Publication
(10) Pub. No.: US 2021/0107593 A1
(43) Pub. Date: Apr. 15, 2021

(54) DRIVE UNIT AND ELECTRICALLY ASSISTED BICYCLE

(71) Applicant: YAMAHA HATSUDOKI KABUSHIKI KAISHA, Iwata-shi (JP)

(72) Inventor: Ryota SUZUKI, Shizuoka (JP)

(21) Appl. No.: 17/065,571

(22) Filed: Oct. 8, 2020

(30) Foreign Application Priority Data
Oct. 11, 2019 (JP) 2019-187526

(51) Int. Cl. B62M 6/55; B62M 3/08; B62M 23/02

(52) U.S. Cl. CPC B62M 6/55; B62M 23/02; B62M 3/08

(57) ABSTRACT

A drive unit mountable on a body frame of an electrically assisted bicycle generates driving power to be transmitted to a wheel. A housing of the drive unit includes a first case including a recess in which an electric motor is accommodated, a second case defining an exterior of the housing together with the first case, and an inner cover that covers at least a portion of the electric motor. The inner cover rotatably supports a gear rotary shaft, and an outer peripheral edge thereof extends between the gear rotary shaft and a pedal crank shaft. The recess in the first case includes a wall extending around the periphery of the electric motor. The wall supports the inner cover.

### CROSS REFERENCE TO RELATED APPLICATIONS

This application claims the benefit of priority to Japanese Patent Application No. 2019-187526 filed on Oct. 11, 2019. The entire contents of this application are hereby incorporated herein by reference.

### BACKGROUND OF THE INVENTION

### 1. Field of the Invention

The present invention relates to a drive unit mountable to a body frame of an electrically assisted bicycle. The present invention also relates to an electrically assisted bicycle including such a drive unit.

### 2. Description of the Related Art

Bicycles are widely prevalent as casual means of transportation, regardless of age and gender. In recent years, electrically assisted bicycles in which a driving power from an electric motor is utilized to assist the pedaling force of a rider have become more and more prevalent. Electrically assisted bicycles are disclosed in Japanese Laid-Open Patent Publication No. 2014-196080, for example.

An electrically assisted bicycle has a drive unit including an electric motor and the like. One known type of drive unit is a type which is located within the hub of the rear wheel, and another is a type which is mounted at the lower end of the body frame (near the bottom bracket). The latter type of drive unit has become predominant in recent years.

The electrically assisted bicycle disclosed in Japanese Laid-Open Patent Publication No. 2014-196080 includes a drive unit which is mounted at the lower end of the body frame. This drive unit includes a housing, an electric motor, a pedal crank shaft, and the like.

The electric motor, which is accommodated in the housing, generates a driving power that is utilized to assist the pedaling force of a rider. The pedal crank shaft extends through the housing along the vehicle's right-left direction. Via arms, pedals are mounted to the pedal crank shaft. Within the housing, the pedal crank shaft is rotatably supported by a pair of bearings. Rotation of the pedal crank shaft is transmitted to the rear wheel via a drive sprocket wheel, a chain, a driven sprocket wheel, and the like.

A conventional drive unit is mainly composed of three exterior parts, specifically: a stator cover by which a stator of an electric motor is covered; one case which accommodates the motor and to which the stator cover is mounted; and another case which is attached so as to face the case.

Each exterior part usually needs to be painted. Therefore, as the number of exterior parts increases, the costs associated with the quality management for the painting increase.

During assembly, as the stator cover and the one case are fixed together, a waterproof sealant needs to be applied; and further as the one case and the other case are fixed together, the sealant needs to be again applied. This necessitates inspections concerning the fixing and the sealant application, thus increasing the costs associated with the assembly.

Decreasing the number of exterior parts would solve the aforementioned problem. On the other hand, decreasing the number of exterior parts may detract from the rigidity of the exterior (and thus the rigidity of the interior), which would have resulted due to the exterior parts being fixed in relatively many places.

### SUMMARY OF THE INVENTION

Preferred embodiments of the present invention provide drive units each of which, while keeping the number of exterior parts at two, maintains the rigidity of the interior thereof, and also provide electrically assisted bicycles including such drive units.

A drive unit according to a preferred embodiment of the present invention is mountable to a body frame of an electrically assisted bicycle to generate a driving power which is transmitted to a wheel of the electrically assisted bicycle, the drive unit including a housing; an electric motor accommodated in the housing; a pedal crank shaft extending through the housing along a right-left direction of the electrically assisted bicycle and being rotatably supported by the housing; a connecting shaft through which the pedal crank shaft extends to transmit a pedaling force from a first end to a second end thereof, the first end being coupled to the pedal crank shaft; a one-way clutch to transmit the pedaling force from the second end of the connecting shaft to a drive sprocket wheel; and a speed reducer including a gear rotary shaft to reduce a rotation speed generated by the electric motor and increase an output torque of the electric motor, wherein the housing includes a first case including a first aperture through which a first end of the pedal crank shaft extends and a recess in which the electric motor is accommodated; a second case including a second aperture through which a second end of the pedal crank shaft extends, the second case and the first case together defining an exterior of the housing; and an inner cover that covers at least a portion of the electric motor accommodated in the recess of the first case, the inner cover including a third aperture through which an output shaft of the electric motor extends, the inner cover rotatably supports the gear rotary shaft of the speed reducer, and an outer peripheral edge of the inner cover extends between the gear rotary shaft and the pedal crank shaft; and the recess of the first case includes a wall extending around a periphery of the electric motor, and the wall supports the inner cover.

The inner cover is supported by the wall of the recess, which is highly rigid, such that misalignment of the inner cover is significantly reduced or prevented. This significantly reduces or prevents misalignment of the gear rotary shaft of the speed reducer supported by the inner cover.

In a preferred embodiment of the present invention, between the recess and the first aperture, the first case includes a slope extending from the first aperture to the wall. The first case including the slope corresponding to the wall enhances the rigidity of the wall.

In a preferred embodiment of the present invention, the first case includes a second recess including the first aperture at a bottom thereof; and the slope defines a portion of the second recess. Because the wall of the recess that accommodates the electric motor is connected to the second recess, the rigidity of the wall of the recess accommodating the electric motor is enhanced.

In a preferred embodiment of the present invention, when the inner cover is viewed in a direction parallel to the output shaft of the electric motor, the outer peripheral edge of the inner cover extends around the periphery of the electric motor. The inner cover does not extend over to the pedal crank shaft and has a small-size, such that the rigidity of the inner cover is enhanced. Since the inner cover has a high rigidity, misalignment of the gear rotary shaft of the speed reducer supported by the inner cover is significantly reduced or prevented.

In a preferred embodiment of the present invention, the outer peripheral edge of the inner cover is fixed to the wall at a plurality of positions. Because the inner cover is fixed to the wall at a plurality of positions, flexure of the inner cover is significantly reduced or prevented.

In a preferred embodiment of the present invention, the inner cover rotatably supports the output shaft of the electric motor. The inner cover supports the gear rotary shaft of the speed reducer and the output shaft of the electric motor. Because both of the gear rotary shaft of the speed reducer and the output shaft of the electric motor are supported by a single part, misalignment between the gear rotary shaft of the speed reducer and the output shaft of the electric motor is significantly reduced or prevented.

In a preferred embodiment of the present invention, the drive unit further includes an alignment structure to determine a relative position between the inner cover and the first case. By aligning the inner cover and the first case, alignment between the gear rotary shaft of the speed reducer and the pedal crank shaft is achieved, thus achieving a smooth power transmission.

In a preferred embodiment of the present invention, the inner cover includes a protrusion or a recess to determine a position of the inner cover relative to the first case, and the first case includes a recess or a protrusion to engage with the protrusion or the recess of the inner cover. By aligning the inner cover and the first case through engagement of the protrusion and the recess, a more accurate alignment between the gear rotary shaft of the speed reducer and the pedal crank shaft is achieved, such that a smooth power transmission is achieved.

In a preferred embodiment of the present invention, the inner cover includes a first hole, and the first case includes a second hole; and a knock pin extends through the first hole into the second hole. By aligning the inner cover and the first case with use of the knock pin, a more accurate alignment between the gear rotary shaft of the speed reducer and the pedal crank shaft is achieved, such that a smooth power transmission is achieved.

In a preferred embodiment of the present invention, the inner cover and the wall include a spigot joint structure in which the inner cover fits into the wall. By aligning the inner cover and the first case via the spigot joint structure (mate fitting), alignment between the gear rotary shaft of the speed reducer and the pedal crank shaft is achieved, such that a smooth power transmission is achieved.

In a preferred embodiment of the present invention, the inner cover and the wall include a spigot joint structure in which the inner cover is able to rotate relative to the wall; the inner cover includes a first hole, and the first case includes a second hole; a knock pin extends through the first hole into the second hole; and the first hole is located at a position on a straight line perpendicular to a line segment connecting the pedal crank shaft and the gear rotary shaft of the speed reducer and on the outer peripheral edge. By providing the first hole at a position which is on the outer peripheral edge and distant from the gear rotary shaft, even if an offset occurs during an alignment process using the knock pin, the misalignment of the gear rotary shaft associated therewith is reduced.

In a preferred embodiment of the present invention, the inner cover and the wall include a spigot joint structure in which the inner cover is able to rotate relative to the wall; the inner cover includes a first hole, and the first case includes a second hole; a knock pin extends through the first hole into the second hole; and the first hole is located at a position which is on the outer peripheral edge and at which an angle between a line segment connecting the pedal crank shaft and the gear rotary shaft of the speed reducer and a tangent from the pedal crank shaft to the outer peripheral edge is closest to 90 degrees. By providing the first hole at a position which is on the outer peripheral edge and distant from the gear rotary shaft, even if an offset occurs during an alignment process using the knock pin, the misalignment of the gear rotary shaft associated therewith is reduced.

In a preferred embodiment of the present invention, the drive unit further includes a circuit board on which a drive circuit to drive the electric motor is mounted, wherein the inner cover includes a first surface and a second surface; the first surface faces the electric motor, and the second surface is opposite to the first surface; and within the housing, the circuit board is located in a space that is on a side of the second surface of the inner cover. The circuit board is located at a position distinct from the recess that accommodates the electric motor. This enables the recess to be small, thus enhancing the rigidity of the wall of the recess.

In a preferred embodiment of the present invention, the inner cover is surrounded by the first case and the second case, and is not exposed outside the drive unit. Because the inner cover is not exposed to the outside, the parts of the housing that need painting are reduced to two, i.e., the first case and the second case. Moreover, the parts of the housing for which waterproof sealant needs to be applied are reduced to two, i.e., the first case and the second case. Thus, the production costs are reduced.

In a preferred embodiment of the present invention, the inner cover is enclosed by the first case and the second case. Because the inner cover is enclosed without being exposed outside, the parts of the housing that need painting are reduced to two, i.e., the first case and the second case. Moreover, the parts of the housing for which waterproof sealant needs to be applied are reduced to two, i.e., the first case and the second case. Thus, the production costs are reduced.

An electrically assisted bicycle according to a preferred embodiment of the present invention includes a drive unit according to any of the above preferred embodiments of the present invention. Because the gear rotary shaft of the speed reducer is supported by the inner cover, an electrically assisted bicycle is achieved in which misalignment of the gear rotary shaft in the drive unit is significantly reduced or prevented.

According to a preferred embodiment of the present invention, a drive unit includes an inner cover that covers at least a portion of the electric motor accommodated in the recess of the first case, and the inner cover includes a third aperture through which an output shaft of the electric motor extends. The inner cover rotatably supports the gear rotary shaft of the speed reducer, and an outer peripheral edge of the inner cover extends between the gear rotary shaft and the pedal crank shaft. The recess of the first case includes a wall extending around a periphery of the electric motor, and the wall supports the inner cover. The inner cover is supported by the wall of the recess (which is a highly rigid portion) of the first case, such that misalignment of the inner cover is significantly reduced or prevented. This significantly reduces or prevents the misalignment of the gear rotary shaft of the speed reducer supported by the inner cover.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a right side view showing an electrically assisted bicycle 10 according to a preferred embodiment of the present invention.

FIG. 2 is a cross-sectional view showing an internal structure of a drive unit 20 which is included in an electrically assisted bicycle 10 according to a preferred embodiment of the present invention.

FIG. 3 is a perspective view of the inside of a first case 211.

FIG. 4 is a perspective view of the outside of the first case 211.

FIG. 5 is a cross-sectional view for describing the relationship between a recess 404 and a second recess 408.

FIG. 6 is a perspective view of the inside of the first case 211, with an inner cover 213 mounted thereon.

FIG. 7 is a plan view for describing the relative positioning between the inner cover 213, a pedal crank shaft 22, and a transmission shaft 241.

FIG. 8 is a diagram showing a circuit board 48 which is provided in the first case 211.

FIG. 9 shows an alignment structure 500 in which the inner cover 213 fits into a wall 406.

FIG. 10 is an enlarged view of the alignment structure 500.

FIG. 11A is a diagram for describing a method for determining an alignment hole(s) by using a knock pin(s).

FIG. 11B is a diagram showing the positions of a first hole(s) R and/or Ra located on an outer peripheral edge 462.

FIG. 11C is a diagram for describing another position that can be used as the position of an alignment hole.

FIG. 12 is a cross-sectional view showing a straight-shaped knock pin 502 inserted in a first hole 213a in the inner cover 213 and a second hole 406a in the wall 406.

FIG. 13 is a diagram showing a first variation of an alignment structure using a knock pin.

FIG. 14 is a diagram showing a second variation of an alignment structure using a knock pin.

### DETAILED DESCRIPTION OF THE PREFERRED EMBODIMENTS

Hereinafter, with reference to the drawings, drive systems according to preferred embodiments of the present invention, and electrically assisted bicycles including such drive systems, will be described. In the description of the preferred embodiments, like component elements will be denoted by like reference numerals, and any redundant description thereof will be omitted. In preferred embodiments of the present invention, the terms “front”, “rear”, “right”, “left”, “up”, and “down” respectively mean the front, rear, right, left, up, and down as viewed from a rider who sits on the saddle (seat) of the electrically assisted bicycle while facing the handle bar. The following preferred embodiments are only illustrative, and the present invention is not limited to the following preferred embodiments.

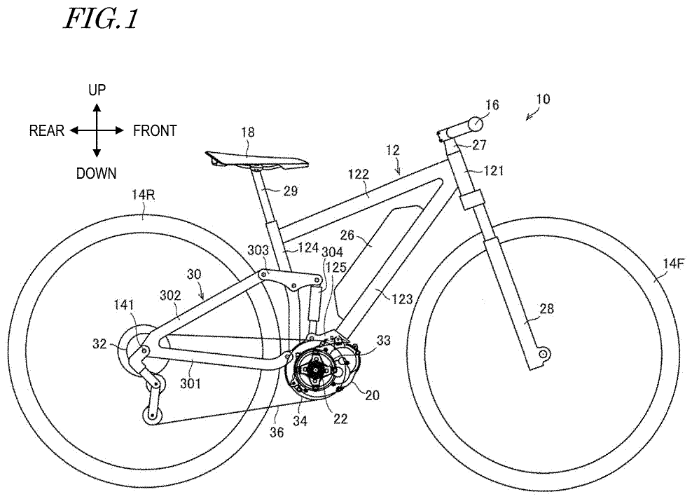

With reference to FIG. 1, an electrically assisted bicycle 10 according to preferred embodiments of the present invention will be described. FIG. 1 is a right side view showing the schematic configuration of the electrically assisted bicycle 10.

The electrically assisted bicycle 10 includes a body frame 12, a front wheel 14F, a rear wheel 14R, a handle bar 16, and a saddle 18. The electrically assisted bicycle 10 further includes a drive unit 20 and a battery unit 26.

The body frame 12 includes a head tube 121, a top tube 122, a down tube 123, a seat tube 124, and a bracket 125.

The head tube 121, extending along the up-down direction, is located at the front of the body frame 12. A stem 27 is inserted in the head tube 121 so as to be able to rotate. The handle bar 16 is fixed at the upper end of the stem 27. Front forks 28 are fixed at the lower end of the stem 27. At the lower end of the front forks 28, the front wheel 14F is mounted so as to be able to rotate. In other words, the front wheel 14F is supported by the body frame 12 via the stem 27 and the front forks 28.

The top tube 122, extending along the front-rear direction, is located at the rear of the head tube 121. The front end of the top tube 122 is connected to the head tube 121. The rear end of the top tube 122 is connected to the seat tube 124.

The down tube 123, extending along the front-rear direction, is located at the rear of the head tube 121. The down tube 123 is located below the top tube 122. The front end of the down tube 123 is connected to the head tube 121. In the example shown in FIG. 1, the front end portion of the down tube 123 is also connected to the front end portion of the top tube 122. The rear end of the down tube 123 is connected to the bracket 125.

The battery unit 26 is mounted on the down tube 123. The battery unit 26 supplies electric power to the drive unit 20. The battery unit 26 includes a battery and a control circuit. The battery is a rechargeable battery that is able to be charged and discharged. The control circuit controls charging and discharging of the battery, and also monitors the output current, remaining power, etc., of the battery.

The seat tube 124, extending along the up-down direction, is located at the rear of the top tube 122 and the down tube 123. The lower end of the seat tube 124 is connected to the bracket 125. In other words, the seat tube 124 extends upward from the bracket 125.

In the example shown in FIG. 1, the seat tube 124 is bent at an intermediate portion along the up-down direction. As a result of this, a lower portion of the seat tube 124 extends along the up-down direction, while an upper portion of the seat tube 124 extends along a direction which is inclined with respect to the up-down direction.

A seat post 29 is inserted in the seat tube 124. The saddle 18 is mounted at the upper end of the seat post 29.

The bracket 125 is located at the lower end of the body frame 12. The bracket 125 supports the drive unit 20. The drive unit 20 mounted on the body frame 12 generates a driving power to be transmitted to a wheel (which herein is the rear wheel 14R). Details of the drive unit 20 will be described below.

The body frame 12 further includes a swingarm 30, a pair of connection arms 303, and a suspension 304. The swingarm 30 includes a pair of chain stays 301 and a pair of seat stays 302.

The pair of chain stays 301 each extend along the front-rear direction. The pair of chain stays 301 are located side-by-side along the right-left direction. The rear wheel 14R is located between the pair of chain stays 301. The pair of chain stays 301 are positioned symmetrically to the right and left. For this reason, FIG. 1 only illustrates the right chain stay 301.

The front end portion of each chain stay 301 is mounted to the bracket 125. In other words, each chain stay 301 extends rearward from the bracket 125. Each chain stay 301 is able to swing with respect to the bracket 125 around an axis which extends along the right-left direction.

A wheel axis 141 of the rear wheel 14R is mounted at the rear end portion of each chain stay 301, in such a manner that the wheel axis 141 itself is unable to rotate. In other words, the pair of chain stays 301 together support the rear wheel 14R in such a manner that the rear wheel 14R is able to rotate around the wheel axis 141. That is, the rear wheel 14R is supported on the body frame 12. A plurality of driven sprocket wheels 32 are fixed on the rear wheel 14R.

The pair of seat stays 302 each extend along the front-rear direction. The pair of seat stays 302 are located side-by-side along the right-left direction. The rear wheel 14R is located between the pair of seat stays 302. The pair of seat stays 302 are positioned symmetrically to the right and left. For this reason, FIG. 1 only illustrates the right seat stay 302.

The rear end portion of the left seat stay 302 is connected to the rear end portion of the left chain stay 301. The rear end portion of the right seat stay 302 is connected to the rear end portion of the right chain stay 301.

The pair of connection arms 303 each extend along the front-rear direction. The pair of connection arms 303 are located side-by-side along the right-left direction. The seat tube 124 is located between the pair of connection arms 303. The pair of connection arms 303 are positioned symmetrically to the right and left. For this reason, FIG. 1 only illustrates the right connection arm 303.

Each connection arm 303 is mounted on the seat tube 124. Each connection arm 303 is able to swing with respect to the seat tube 124 around an axis which extends along the right-left direction.

As viewed from a side surface of the vehicle, the front end of each connection arm 303 is located forward of the seat tube 124. As viewed from a side surface of the vehicle, the rear end of each connection arm 303 is located rearward of the seat tube 124.

The rear end portion of the left connection arm 303 is mounted at the front end portion of the left seat stay 302. The left connection arm 303 is able to swing with respect to the left seat stay 302 around an axis which extends along the right-left direction.

The rear end portion of the right connection arm 303 is mounted at the front end portion of the right seat stay 302. The right connection arm 303 is able to swing with respect to the right seat stay 302 around an axis which extends along the right-left direction.

The suspension 304 is located forward of the seat tube 124 and rearward of the down tube 123. The upper end portion of the suspension 304 is mounted on the pair of connection arms 303. The suspension 304 is able to swing with respect to the pair of connection arms 303 around an axis which extends along the right-left direction. The lower end portion of the suspension 304 is mounted on the bracket 125. The suspension 304 is able to swing with respect to the bracket 125 around an axis which extends along the right-left direction. The position at which the bracket 125 is mounted to the suspension 304 is forward of the position at which the bracket 125 is mounted to the seat tube 124.

Via a supporting member 33, a drive sprocket wheel 34 is mounted on the drive unit 20. A chain 36 is wound around the drive sprocket wheel 34 and the driven sprocket wheels 32.

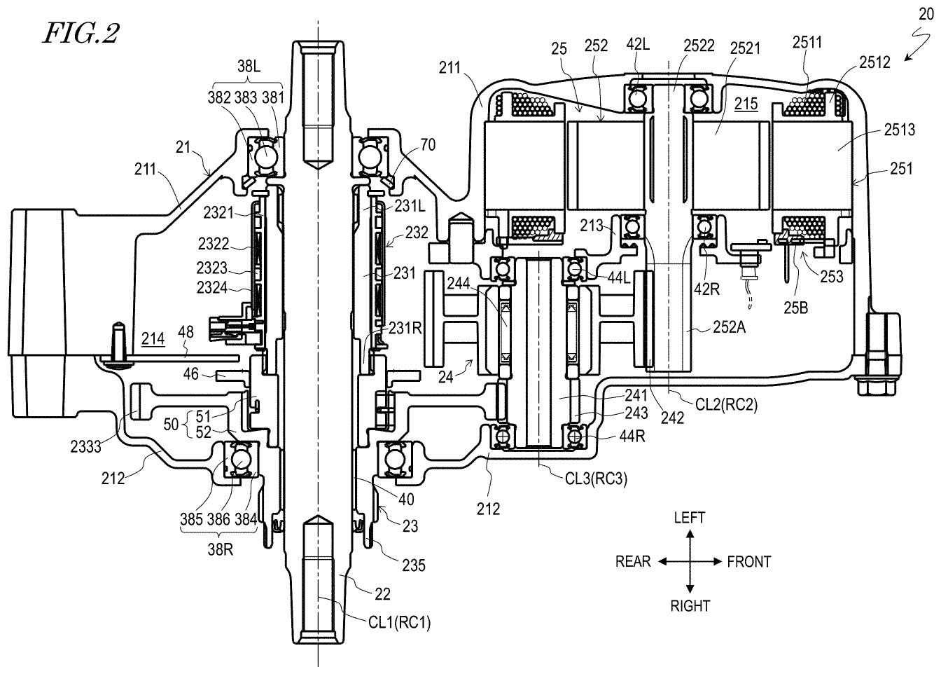

With reference to FIG. 2, an exemplary configuration of the drive unit 20 will be described. FIG. 2 is a cross-sectional view showing the internal structure of the drive unit 20.

As shown in FIG. 2, the drive unit 20 includes a housing 21, a pedal crank shaft 22, a rotary shaft (axle) 23, a speed reducer 24, and an electric motor 25.

First, the configuration of the housing 21 according to a preferred embodiment of the present invention will be described.

The housing 21 is fixed to the bracket 125 (FIG. 1) by a plurality of fastening members. The housing 21 includes a first case 211, a second case 212, and an inner cover 213. The first case 211, the second case 212, and the cover 213 are each preferably made of a metal material (e.g., an aluminum alloy).

In terms of the right-left direction, the second case 212 is overlaid on the first case 211 from the right. The first case 211 is fixed to the second case 212 by a plurality of fastening members. As a result, a space 214 is provided between the first case 211 and the second case 212.

In terms of the right-left direction, the inner cover 213 is overlaid from the right to close the recess of the first case 211 in which the electric motor 25 is accommodated. The inner cover 213 is fixed to the first case 211 by a plurality of fastening members. As a result, between the left portion of the first case 211 and the inner cover 213, a space 215 that is covered by the first case 211 and the inner cover 213 is provided. The electric motor 25 is accommodated in the space 215.

Next, the configuration of the pedal crank shaft 22 according to a preferred embodiment of the present invention will be described.

The pedal crank shaft 22 extends through the housing 21 along the vehicle's right-left direction. In other words, the center axis CL1 of the pedal crank shaft 22 extends along the right-left direction. As viewed along the axial direction (thrust direction) of the pedal crank shaft 22, the center axis CL1 defines the axis of rotation RC1 of the pedal crank shaft 22. The pedal crank shaft 22 rotates with respect to the housing 21 around the center axis CL1.

The pedal crank shaft 22 is rotatably supported by a pair of bearings 38L and 38R within the housing 21. One (38L) of the pair of bearings 38L and 38R is located at one side along the thrust direction (which herein is the left side), hereinafter referred to as the “first bearing”. On the other hand, the other (38R) of the pair of bearings 38L and 38R is located at the other side (which herein is the right side) along the thrust direction, hereinafter referred to as the “second bearing”.

The first bearing 38L is preferably a roller bearing that includes an inner ring 381, an outer ring 382, and a rolling element 383. The first bearing 38L does not move along the thrust direction relative to the pedal crank shaft 22. In the example shown in FIG. 2, the inner ring 381 of the first bearing 38L is press-fitted to the pedal crank shaft 22. The outer ring 382 of the first bearing 38L is urged in the left direction by an elastic member 70.

The second bearing 38R is preferably a roller bearing that includes an inner ring 384, an outer ring 385, and a rolling element 386. The second bearing 38R rotatably supports the pedal crank shaft 22, via an outer member 52 of a one-way clutch 50 and a plain bearing(s) 40, which will be described below.

The pedal crank shaft 22 extends through the rotary shaft 23. The rotary shaft 23 is accommodated in the housing 21. Details of the rotary shaft 23 will be described below. The pedal crank shaft 22 includes a pair of right- and left-crank arms (not shown) mounted thereto. Pedals (not shown) are mounted on the crank arms.

Next, the configurations of the electric motor 25 and the speed reducer 24 according to a preferred embodiment of the present invention will be described.

The electric motor 25 is accommodated in, and fixed to, the housing 21. The electric motor 25 generates a driving power which assists the travel of the electrically assisted bicycle 10. The electric motor 25 includes a stator 251 and a rotor 252.

The stator 251 includes a plurality of (e.g., fourteen) bobbins 2512, around which coils 2511 are wound. An iron core 2513 is inserted in each bobbin 2512. The stator 251 is located in the space 215. In this state, the stator 251 is fixed to the first case 211.

A supporting member 253 is mounted on the stator 251. The supporting member 253 is preferably made of a resin material. A plurality of busbars 25B are embedded in the supporting member 253. Each busbar 25B is connected to a corresponding coil 2511. By controlling power to the busbars 25B, a magnetic force is generated in the stator 251.

The rotor 252 is located inside the stator 251. The center axis CL2 of the rotor 252 is parallel or substantially parallel to the center axis CL1 of the pedal crank shaft 22. In other words, the rotor 252 is parallel or substantially parallel to the pedal crank shaft 22. As viewed along the axial direction of the pedal crank shaft 22, the center axis CL2 defines the axis of rotation RC2 of the rotor 252.

The rotor 252 includes a rotor main body 2521 and an output shaft 2522. These will now be described. The outer peripheral surface of the rotor main body 2521 is alternately magnetized into N-poles and S-poles along the peripheral direction. In the present preferred embodiment, there are seven N-poles and seven S-poles.

The output shaft 2522 extends through the rotor main body 2521. The output shaft 2522 is fixed to the rotor main body 2521. In other words, the output shaft 2522 rotates together with the rotor main body 2521.

With the two bearings 42L and 42R, the output shaft 2522 is supported so as to be able to rotate relative to the housing 21 around the center axis CL2. The bearing 42L is fixed to the first case 211. The bearing 42R is located farther to the right side than is the rotor main body 2521, and is fixed to the inner cover 213. The output shaft 2522 extends through the inner cover 213. In the present preferred embodiment, the inner cover 213 and the bearing 42R together support the output shaft 2522 so that the output shaft 2522 is able to rotate; however, such configuration is not essential. For example, the bearing 42R may be provided on the second case 212, and the output shaft 2522 may be supported by the bearing 42R and the second case 212 so as to be able to rotate. In a portion of the output shaft 2522 that is located in the space 214, an output gear 252A is provided. The output gear 252A is a helical gear, for example.

The speed reducer 24 is accommodated in the housing 21. Specifically, the speed reducer 24 is located within the space 214. The speed reducer 24 includes a transmission shaft 241, a first transmission gear 242, and a second transmission gear 243. In the present specification, the transmission shaft 241 may be referred to as a “gear rotary shaft”.

The transmission shaft 241 is located in the housing 21. The center axis CL3 of the transmission shaft 241 is parallel or substantially parallel to the center axis CL1 of the pedal crank shaft 22. In other words, the transmission shaft 241 extends parallel or substantially parallel to the center axis CL1 of the pedal crank shaft 22. As viewed along the axial direction of the transmission shaft 241, i.e., the axial direction of the pedal crank shaft 22, the center axis CL3 defines the axis of rotation RC3 of the transmission shaft 241.

With the two bearings 44L and 44R, the transmission shaft 241 is supported so as to be able to rotate around the center axis CL3. The bearing 44L is fixed to the inner cover 213. In other words, the inner cover 213 rotatably supports the transmission shaft 241. The bearing 44R is fixed to the second case 212.

The first transmission gear 242 is preferably made of a resin material, for example. The first transmission gear 242 is provided on the transmission shaft 241. The first transmission gear 242 is located closer to the bearing 44L than to the bearing 44R along the axial direction of the transmission shaft 241. The first transmission gear 242 meshes with the output gear 252A. As a result, a driving power which is generated by the electric motor 25 is transmitted from the output gear 252A to the first transmission gear 242. Between the first transmission gear 242 and the transmission shaft 241, a one-way clutch 244 is provided. As a result, the rotary force of the output gear 252A in the forward-rotation direction is transmitted to the transmission shaft 241 via the first transmission gear 242, while the rotary force of the output gear 252A in the backward-rotation direction is not transmitted to the transmission shaft 241. Moreover, the one-way clutch 244 prevents the rotary force of the pedal crank shaft 22 in the forward-rotation direction that is generated by the human force of the rider from being transmitted to the electric motor 25. The first transmission gear 242 is larger in diameter than the output gear 252A, and has more teeth than does the output gear 252A. In other words, the speed of the first transmission gear 242 is slower than that of the output gear 252A.

The second transmission gear 243 is preferably made of a metal material (e.g., iron). The second transmission gear 243 is provided on the transmission shaft 241. The second transmission gear 243 is located at a different position from the first transmission gear 242 along the axial direction of the transmission shaft 241. In the present preferred embodiment, the transmission shaft 241 and the second transmission gear 243 are monolithic, i.e., a single unitary piece. The second transmission gear 243 rotates together with the transmission shaft 241. Note that the second transmission gear 243 may be fixed to the transmission shaft 241 via a serration coupling (or press-fitting).

The rotary shaft 23 is coaxial with the pedal crank shaft 22, and is able to rotate with the pedal crank shaft 22. The rotary shaft 23 includes a connecting shaft 231 and a one-way clutch 50.

The connecting shaft 231 has a cylindrical shape. The pedal crank shaft 22 is inserted in the connecting shaft 231. The connecting shaft 231 is coaxial with the crank shaft 22.

The left end (i.e., a first end) 231 of the connecting shaft 231 is linked to the pedal crank shaft 22 via a serration coupling or the like. As a result, regardless of whether the pedal crank shaft 22 rotates in the forward-rotation direction or the backward-rotation direction, the connecting shaft 231 rotates together with the crank shaft 22.

A torque detector 232 is provided around the connecting shaft 231. The torque detector 232 is supported by the first case 211.

The torque detector 232 detects a torque that occurs in the connecting shaft 231 as the driver moves the pedals. The torque detector 232 is preferably a magnetostrictive type. The torque detector 232 outputs a signal which is in accordance with the detected torque to a controller which is mounted on the circuit board 48. By referring to the torque signal which has been detected by the torque detector 232, the controller determines the state of pedaling by the driver, and thus controls the electric motor 25.

The torque detector 232 includes an attachment shaft 2321, a coil 2322, a detection element 2323, and a shield 2324.

The attachment shaft 2321 is mounted on the outer peripheral surface of the connecting shaft 231, and is able to relatively rotate with respect to the connecting shaft 231. The coil 2322 is provided on the outer peripheral surface of the attachment shaft 2321. A predetermined voltage is applied to the coil 2322. The detection element 2323 detects a change in voltage of the coil 2322 that is caused by distortion of the connecting shaft 231. As a result, a torque occurring in the connecting shaft 231, i.e., a torque occurring in the pedal crank shaft 22 rotating integrally with the connecting shaft 231, is detected. The shield 2324 prevents deterioration of the detection accuracy of the detection element 2323. The shield 2324 does not rotate with the connecting shaft 231.

Next, the configuration of the one-way clutch 50 according to a preferred embodiment of the present invention will be described.

Along the axial direction of the pedal crank shaft 22, the one-way clutch 50 is located to the right side of the torque detector 232. The one-way clutch 50 is coaxial with the pedal crank shaft 22. The one-way clutch 50 includes an inner member 51 and an outer member 52.

The inner member 51 has a cylindrical shape. At the left end (i.e., the first end) of the inner member 51, the right end (i.e., the second end) 231R of the connecting shaft 231 is inserted. The inner member 51 is coaxial with the connecting shaft 231. In this state, the right end 231R of the connecting shaft 231 is linked to the left end of the inner member 51 via a serration coupling or the like. As a result, regardless of whether the connecting shaft 231 rotates in the forward-rotation direction or the backward-rotation direction, the inner member 51 rotates together with the connecting shaft 231. In other words, regardless of whether the pedal crank shaft 22 rotates in the forward-rotation direction or the backward-rotation direction, the inner member 51 rotates together with the pedal crank shaft 22. The connecting shaft 231 and the inner member 51 function as a crank rotation inputting shaft that rotates integrally with the pedal crank shaft 22.

A ring magnet 46 is fixed to the outer peripheral surface of the inner member 51. As viewed along the axial direction of the pedal crank shaft 22, the ring magnet 46 is located at a position that overlaps a portion of the circuit board 48.

The ring magnet 46 rotates together with the inner member 51. By using a detection element provided on the circuit board 48 to detect a change in the magnetic field that is caused by the rotation of the ring magnet 46, rotation of the pedal crank shaft 22 is detected.

The outer member 52 has a cylindrical shape. The pedal crank shaft 22 is inserted in the outer member 52. The plain bearing(s) is located between the outer member 52 and the pedal crank shaft 22. As a result of this, the outer member 52 is able to rotate coaxially with the pedal crank shaft 22.

Between the outer member 52 and the inner member 51, a ratchet mechanism as a one-way clutch mechanism is provided. As a result, a rotary force of the inner member 51 in the forward-rotation direction is transmitted to the outer member 52, while the rotary force of the inner member 51 in the backward-rotation direction is not transmitted to the outer member 52. Moreover, a rotary force of the outer member 52 in the forward-rotation direction that has occurred through the rotation of the electric motor 25 is not transmitted to the inner member 51.

The outer member 52 is supported by the second bearing 38R so as to be able to rotate relative to the housing 21 around the center axis CL1 of the pedal crank shaft 22. The outer ring 385 of the second bearing 38R is free-fitted to the second case 212, with the inner ring 384 thereof being press-fitted to the outer member 52 of the one-way clutch 50.

The outer member 52 extends through the second case 212. The drive sprocket wheel 34 (FIG. 1) is mounted to a portion of the outer member 52 that is located outside (i.e., on the right side of) the housing 21, via the supporting member 33 (FIG. 1).

The outer member 52 includes a gear 2333. The gear 2333 meshes with a second transmission gear 243 of the speed reducer 24. The gear 2333 is larger in diameter than the second transmission gear 243, and has more teeth than does the second transmission gear 243. That is, the rotational speed of the gear 2333 is slower than the rotational speed of the second transmission gear 243.

The outer member 52 transmits a resultant force combining a human force (pedaling force) which is transmitted to the second end 231R of the connecting shaft 231 and an assisting driving power from the electric motor 25 to the drive sprocket wheel 34. With the outer member 52, a resultant force outputting shaft 235 which outputs a resultant force combining the human force which is input via the one-way clutch 50 and the assisting driving power which is input via the gear 2333 is being realized. The resultant force outputting shaft 235 is included in the rotary shaft 23.

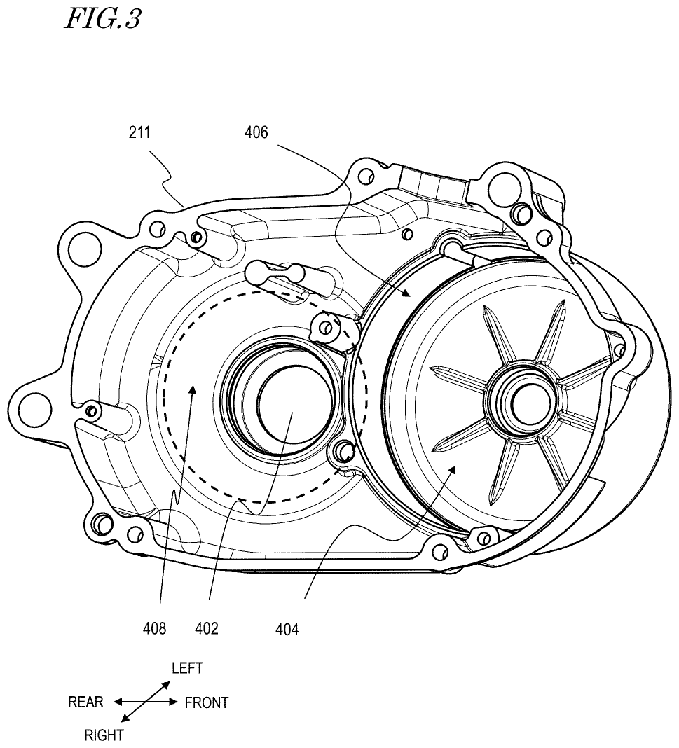

Hereinafter, with reference to FIG. 3 to FIG. 14, the first case 211 and second case 212 and the inner cover 213 according to a preferred embodiment of the present invention will be described in more detail.

FIG. 3 is a perspective view of the inside of the first case 211. The first case 211 includes a first aperture 402 through which one end of the pedal crank shaft 22 extends, and a recess 404. Note that the second case 212 also includes an aperture (second aperture) through which another end of the pedal crank shaft 22 extends. As shown in FIG. 2 (although a perspective view of the second case 212 including the second aperture is omitted), the second case 212 is fixed to the first case 211 as if it is a lid for the first case 211; thus, the second case 212 and the first case 211 together define the exterior of the housing 21.

The electric motor 25 is accommodated in the recess 404 in the first case 211. Therefore, no cover to cover the stator of the electric motor 25 is needed.

The recess 404 includes a wall 406 that fits around the periphery of the electric motor 25 when the electric motor 25 is accommodated in the recess 404. In the example shown, a portion (i.e., substantially the front half) of the wall 406 that corresponds to the “front” of the first case 211 is monolithic with the first case 211. On the other hand, the remainder (i.e., substantially the rear half) of the wall 406 is provided as a structure inside the first case 211.

As will be described in detail below, the wall 406 functions as a portion of an alignment structure that determines the relative position between the inner cover 213 and the first case 211. Assuming that the inner cover 213 has a substantially planar circular shape, the alignment structure uniquely determines the position of the inner cover 213 along the front-rear direction and the right-left direction within the first case 211, while the inner cover 213 determines the position concerning the angle of rotation. The wall 406 may be utilized in order to determine the positions of the inner cover 213 along the front-rear direction and the right-left direction within the first case 211. Although FIG. 3 illustrates the wall 406 as being provided around the entire periphery of the electric motor 25, the wall 406 does not need to extend around the entire periphery. For example, it may extend around about 2/3 of the entire periphery of the electric motor 25.

In addition to the recess 404, the first case 211 also includes a second recess 408. The second recess 408 is provided within a range substantially surrounded by the broken line. When the first aperture 402 is regarded as the bottom, the second recess 408 is tapered toward the bottom. In other words, the second recess 408 would correspond to the inner surface of a circular frustum whose upper base is the first aperture 402.

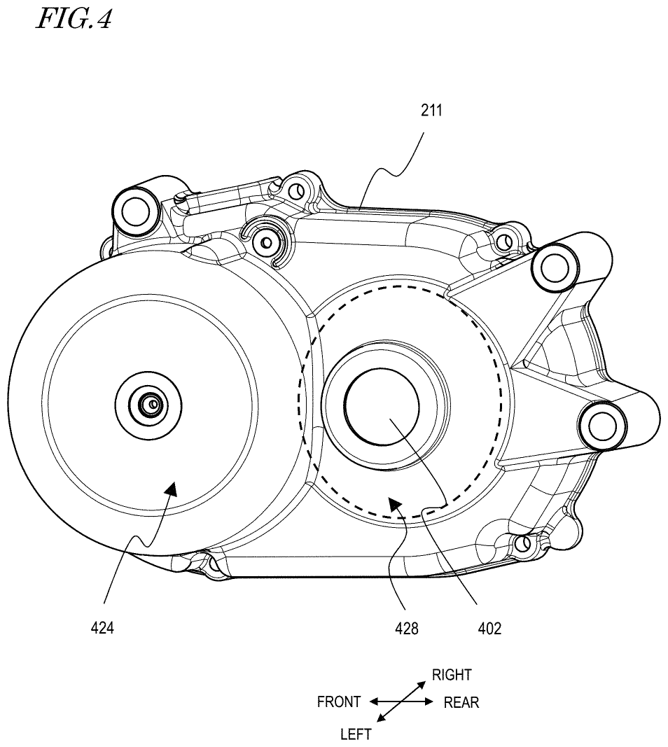

FIG. 4 is a perspective view of the outside of the first case 211. As viewed from the outside, a convex portion 424 and a second convex portion 428 appear in the first case 211, corresponding respectively to the recess 404 and the further recess 408.

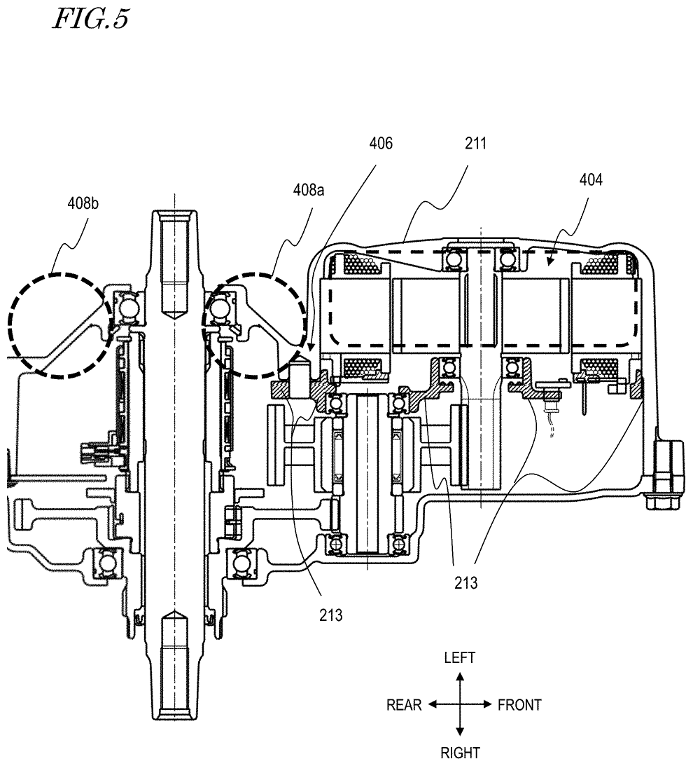

FIG. 5 is a cross-sectional view for describing the relationship between the recess 404 and the second recess 408. FIG. 5 shows slopes 408a and 408b, which define portions of the second recess 408. The region where the recess 404 and the slope 408a meet define an upper end of a portion of the wall 406. In other words, the wall 406 is ridge-shaped. Since the recess 404 and the second recess 408 define the backside structure of the convex portion 424 and the second convex portion 428 (which constitute the exterior), a sufficiently high rigidity is achieved. Since the inner cover 213 is supported by utilizing the recess 404 and the second recess 408 as portions of the wall 406, the rigidity of the wall 406 is enhanced, thus enabling the inner cover 213 to be firmly supported.

As shown in FIG. 5, the inner cover 213 is surrounded by the first case 211 and the second case 212, without being exposed outside the drive unit 20. In other words, the inner cover 213 is enclosed within the drive unit 20. Since the inner cover 213 is enclosed without being exposed to the outside, the parts of the housing that need painting are reduced to two, i.e., the first case 211 and the second case 212. Moreover, the parts of the housing for which waterproof sealant needs to be applied are reduced to two, i.e., the first case 211 and the second case 212. Thus, the production costs are reduced.

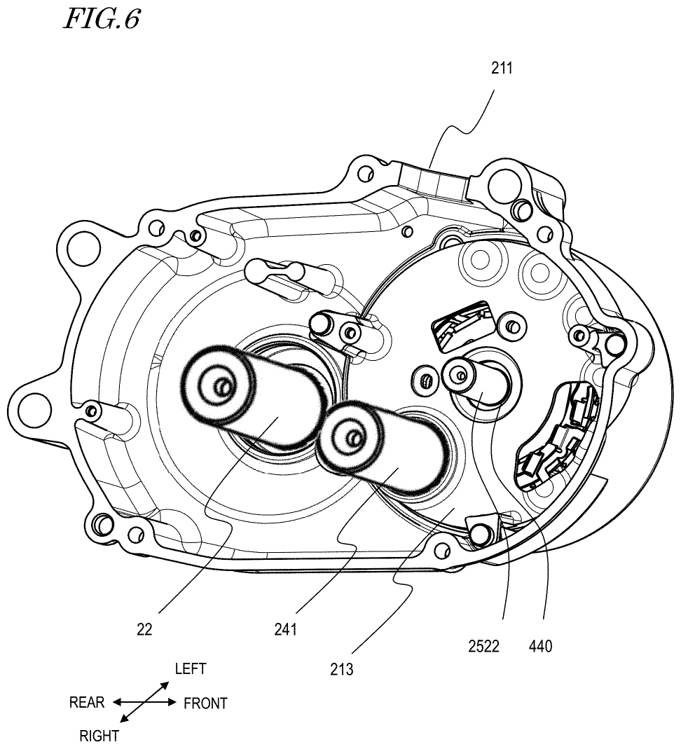

Next, the inner cover 213 will be described in detail with reference to FIG. 6.

FIG. 6 is a perspective view of the inside of the first case 211, with the inner cover 213 mounted thereon. The electric motor 25 is accommodated in the recess 404 of the first case 211. The inner cover 213 is mounted so as to cover at least a portion of the electric motor 25. The inner cover 213 includes an aperture 440, through which the output shaft 2522 of the electric motor 25 extends in the “right” direction. In the present specification, the aperture 440 may be referred to as the “third aperture”.

The range of the electric motor 25 that is covered by the inner cover 213 may be its substantial entirety, except for the hole through which the output shaft 2522 is passed; the hole through which wiring of the electric motor 25 is passed; and any other necessary gaps, for example.

Together with the bearing 44L mounted on the inner cover 213, the inner cover 213 supports one end of the transmission shaft (gear rotary shaft) 241. As described above, the inner cover 213 is supported by the wall 406 of the recess 404, which is highly rigid; therefore, misalignment of the inner cover 213 is significantly reduced or prevented. This also significantly reduces or prevents misalignment of the transmission shaft 241 supported by the inner cover 213. In FIG. 6, the output gear 252A and the like to be provided in connection with the transmission shaft 241 are omitted from illustration.

By way of the output gear 252A, the first transmission gear 242, and the one-way clutch 244, the transmission shaft 241 receives a driving power that is generated by the electric motor 25. When the transmission shaft 241 is misaligned (offset), the engagement between the output gear 252A and the first transmission gear 242 may be affected so that the driving power may not be properly transmitted. In the present preferred embodiment, unlike a conventional drive unit whose exterior parts include three pieces or more, the drive unit is composed only of the two pieces of the first case 211 and the second case 212. Moreover, the inner cover 213 is provided so as to support the transmission shaft 241 at a position of high rigidity to significantly reduce or prevent flexure or the like, such that misalignment (offset) of the transmission shaft 241 is significantly reduced or prevented. Moreover, by providing a hole in the inner cover 213 through which the output shaft 2522 of the electric motor 25 extends, and also by fixing the position at which to support the transmission shaft 241, the interval between both shafts is fixed, such that the inter-shaft precision between both shafts is improved.

In the present preferred embodiment, one reason for providing the inner cover 213 is to support the transmission shaft 241 with a high precision. While the inner cover 213 also has the function of a “lid” covering the electric motor 25, this function is not essential. Accordingly, the function of the inner cover 213 of supporting the transmission shaft 241 may be separated from its function as a “lid” covering the electric motor 25, such that the respective functions may be realized by more than one member. For example, the function of the inner cover 213 of supporting the transmission shaft 241 may be achieved by using a metal frame (which is supported by the highly-rigid wall 406) to fix the bearing 44L, and supporting the transmission shaft (gear rotary shaft) 241 at one end. In this case, the metal frame is encompassed within the meaning of “inner cover” as used in the present specification. Its function as a “lid” may be achieved by adding a resinous cover, for example. A resinous cover is relatively easy to process even into a complicated shape. While providing necessary gaps, it is able to be shaped so as to cover the other portions of the electric motor 25.

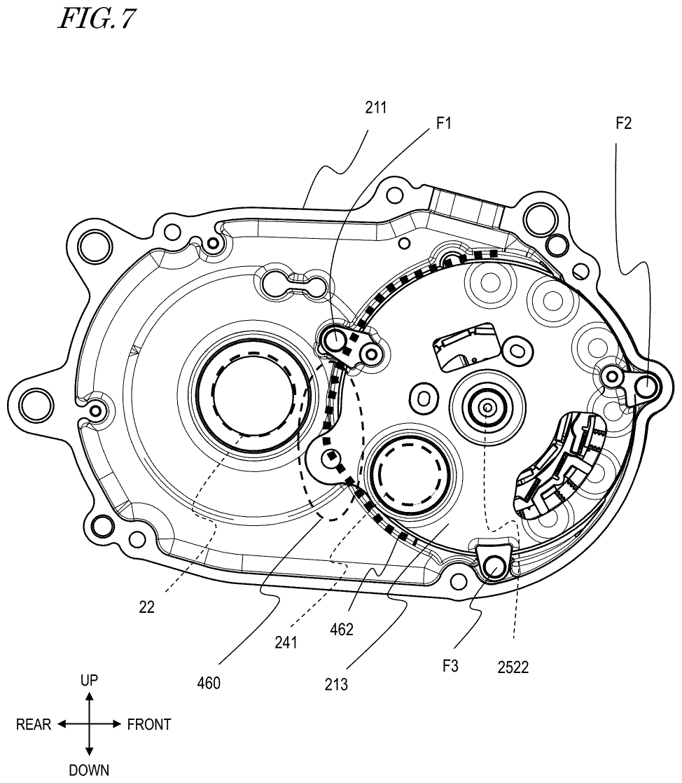

In FIG. 6, a portion of the pedal crank shaft 22 is shown for reference sake. This relates to the physical arrangement and configuration of the inner cover 213 as will be described next. With reference to FIG. 7, the arrangement and configuration will now be described.

FIG. 7 is a plan view for describing the relative positioning between the inner cover 213, the pedal crank shaft 22, and the transmission shaft 241. Between the pedal crank shaft 22 and the transmission shaft 241 indicated with broken lines, a portion 460 of an outer peripheral edge 462 of the inner cover 213 extends. As used herein, the “outer peripheral edge” merely refers to the edge of the inner cover 213. The inner cover 213 may have any arbitrary shape, without being limited to a circle.

As shown in FIG. 7, when the inner cover is viewed from a direction that is parallel to the output shaft 2522 of the electric motor 25, the outer peripheral edge 462 of the inner cover 213 extends around the periphery of the electric motor 25. The inner cover 213 does not extend over to the pedal crank shaft 22, and is relatively small-sized, such that the rigidity of the inner cover 213 itself is enhanced.

The inner cover 213 is fixed to the first case 211 at a plurality of positions F1 to F3. In the present preferred embodiment, the positions F1 to F3 are all located on the wall 406. Since the inner cover 213 is fixed at the positions F1 to F3 by utilizing the wall 406 (which has a high rigidity) between the pedal crank shaft 22 and the transmission shaft 241, and is further supported along the wall 406, flexure of the inner cover 213 is significantly reduced or prevented. Also because of the high rigidity of the inner cover 213, misalignment of the transmission shaft 241 being supported by the inner cover 213 is also significantly reduced or prevented.

Although the positions F1 to F3 may be chosen arbitrarily, they are preferably located at positions near the transmission shaft 241 and the output shaft 2522 of the electric motor 25, for example; the closer to the transmission shaft 241 and the output shaft 2522 of the electric motor 25, the higher the rigidity near each shaft is. As for the method of fixing, screws may be used, or fixing pins may be press-fitted, for example.

Prior to fixing the inner cover 213 to the wall 406, an alignment is performed to determine the relative position between the inner cover 213 and the first case 211. This alignment will be described below.

In connection with provision of the inner cover, a configuration that lacks the wall 406 (FIG. 3) existing between the recess 404 and the second recess 408 may be possible. An example of such configuration may be where the inner cover 213 extends throughout the interior of the first case 211, such that it is supported only by the inner surface of the first case 211, for example. However, in such an example, the inner cover may flex to possibly cause a misalignment of the transmission shaft 241. On the other hand, thickening the inner cover 213 in order to prevent flexure of the inner cover will increase the weight and cost. This makes the configuration according to the present preferred embodiment more advantageous.

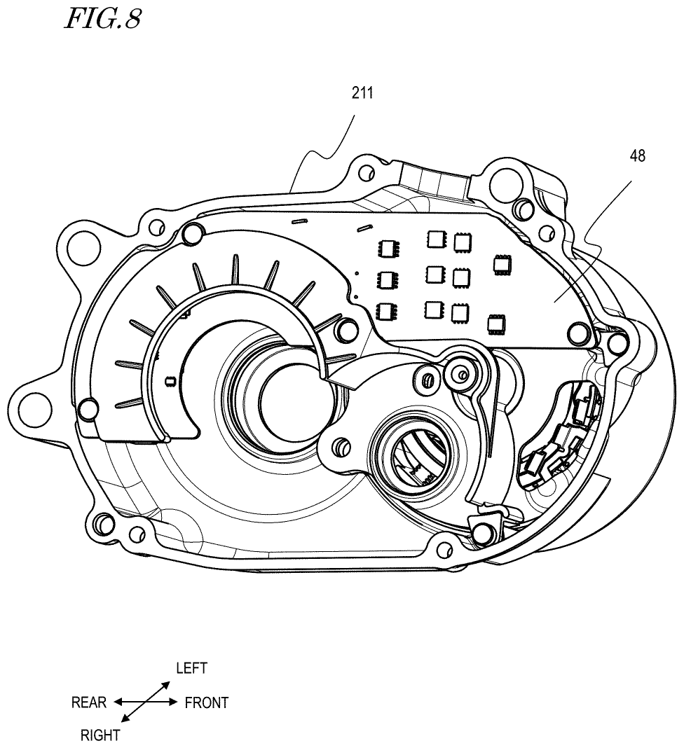

FIG. 8 shows a circuit board 48 which is provided in the first case 211. On the circuit board 48, a drive circuit to drive the electric motor 25 is mounted. The circuit board 48 is provided on the “right” side of the inner cover 213. To illustrate this more specifically, the surface of the inner cover 213 that faces the electric motor 25 will be referred to as the “first surface”, and the opposite surface as the “second surface”. The circuit board 48 is located in a space within the first case 211 that is on the second surface side. Thus, the electric motor 25 and the circuit board 48 are not integral, and the circuit board 48 is located in a space that is distinct from the recess 404 in which the electric motor 25 is accommodated. As a result, the volume of the recess 404 is reduced, such that rigidity of the wall 406 of the recess 404 is enhanced. In the present preferred embodiment, the circuit board 48 and the inner cover 213 are provided between the electric motor 25 and the place of engagement between the output shaft 2522 and the transmission shaft 241. As a result, even in the case in which grease (which may be injected in the place of engagement between the output shaft 2522 of the electric motor 25 and the transmission shaft 241 for wear prevention) scatters or drips, the grease is able to be prevented from intruding into the recess 404 where the electric motor 25 is accommodated. As the geometric area in which the inner cover 213 covers the electric motor 25 is increased, the intrusion of grease is more effectively prevented.

The above description illustrates that the circuit board 48 is provided in the first case 211. However, so long as the above-described relative positioning is maintained, the circuit board 48 may be provided in the second case 212, rather than in the first case 211. In other words, so long as the above-described relative positioning is maintained within the housing of the drive unit 20, the circuit board 48 may be located either in the first case 211 or in the second case 212.

In order to protect the circuitry on the circuit board 48, a cover which may be resinous, for example, may be provided on the “right” side of the circuit board 48.

Next, the alignment to be performed when mounting the inner cover 213 to the first case 211 will be described.

The first case 211 according to the present preferred embodiment includes an alignment structure to achieve alignment. The “alignment structure” includes structure in which the inner cover 213 fits into the wall 406, or a structure in which a knock pin is used to achieve alignment. In the present preferred embodiment, alignment structures are provided in two places. Specifically, a structure in which the inner cover 213 fits into the wall 406 (one place) and a structure in which a knock pin is used to achieve alignment (one place) may be provided; alternatively, structures in which a knock pin is used to achieve alignment may be provided in two places.

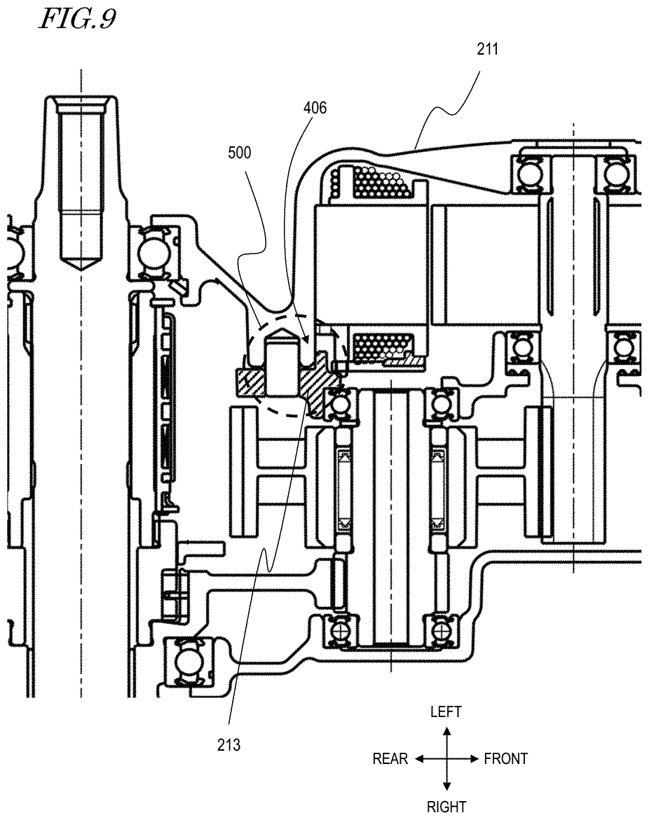

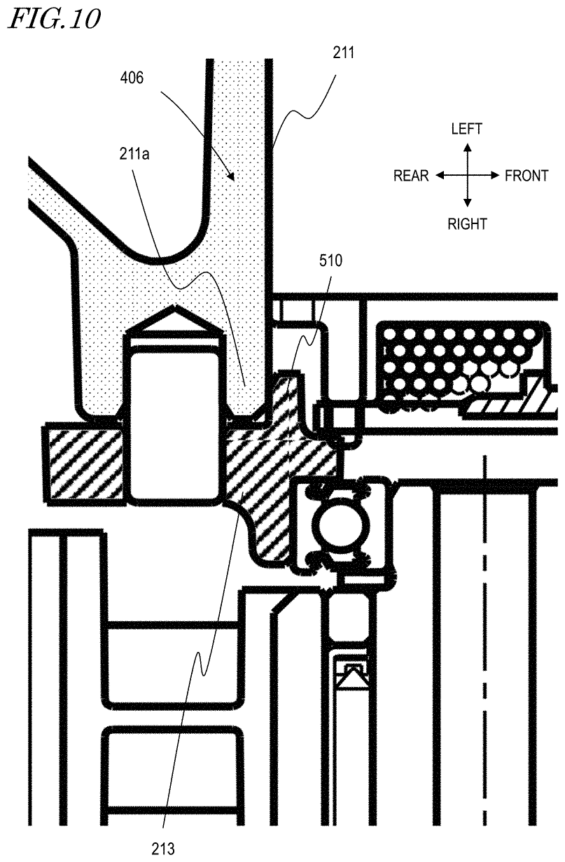

FIG. 9 shows an alignment structure 500 in which the inner cover 213 fits into the wall 406. FIG. 10 is an enlarged view of the alignment structure 500. A first guide 510 protrudes from the first surface (i.e., the “left” surface) of the inner cover 213 toward the “left”, and fits inside a second guide 211a on the wall 406. The first guide 510 and the second guide 211a are provided on the inner cover 213 and the wall 406, respectively, so as to come in contact when the inner cover 213 is properly fitted in the wall 406.

For simplicity of explanation, it is assumed that the first guide 510 provided on the inner cover 213 appears circular on the first surface, and also that the second guide 211a on the wall 406 is circular. Given that the first guide 510 has a diameter of about 100 mm, for example, the second guide 211a has a diameter of about 100.1 mm, for example. The first guide 510 and the second guide 211a fit together substantially without any rattling along the front-rear direction. The alignment structure 500 as such may be referred to herein as a “spigot joint structure (mate fitting)”.

Since the spigot joint structure is created by the first guide 510 of the inner cover 213 and the second guide 211a of the wall 406, at any position where the wall 406 is not provided around the periphery of the electric motor 25, the first guide 510 does not need to be provided on the opposing inner cover 213 either.

Next, a structure in which a knock pin is used to achieve alignment will be described.

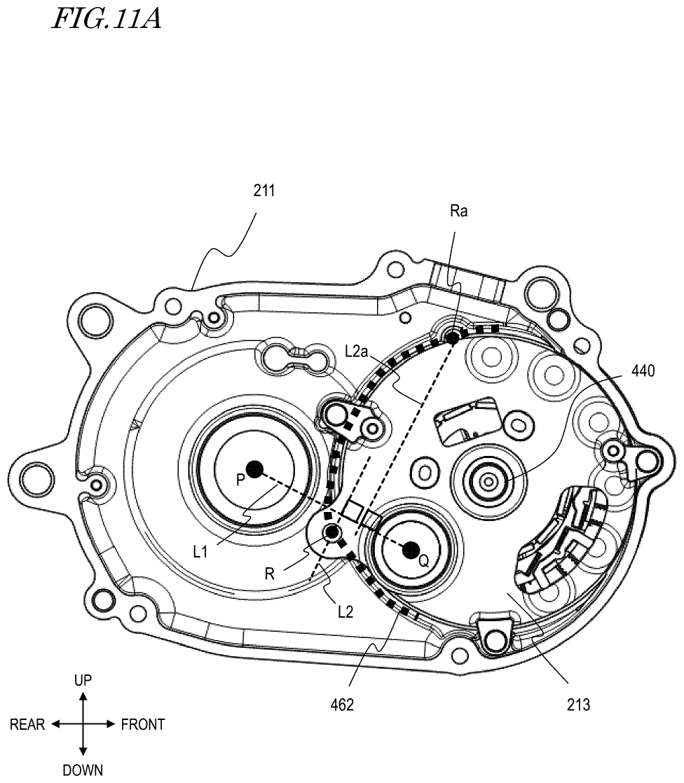

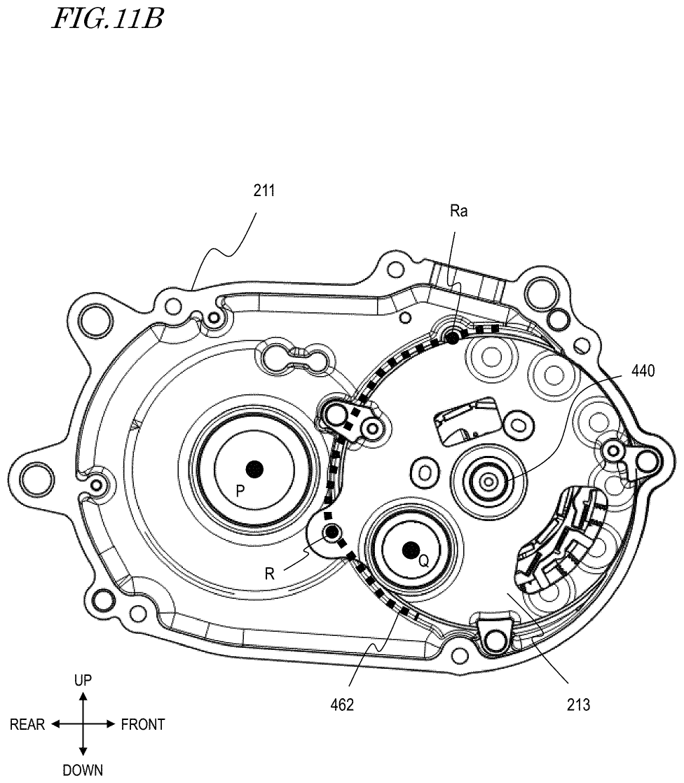

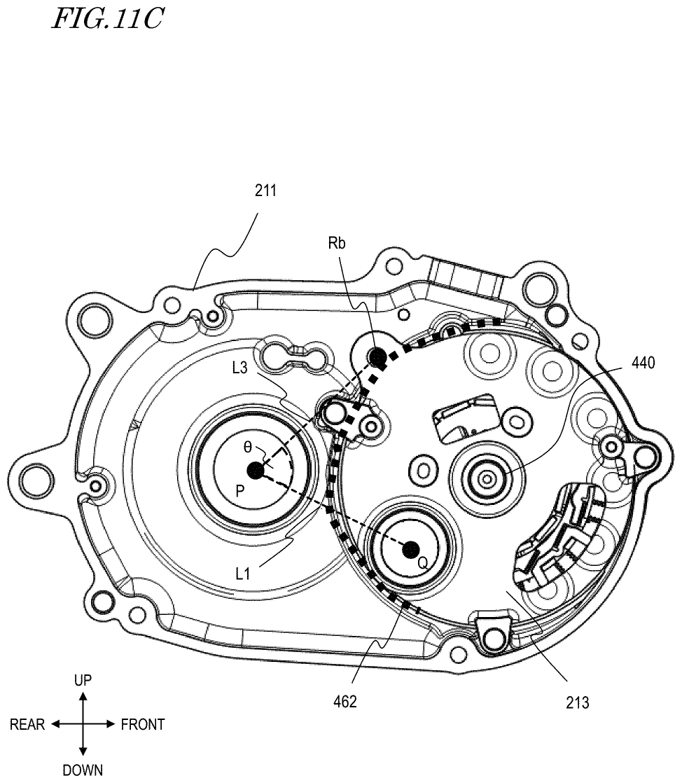

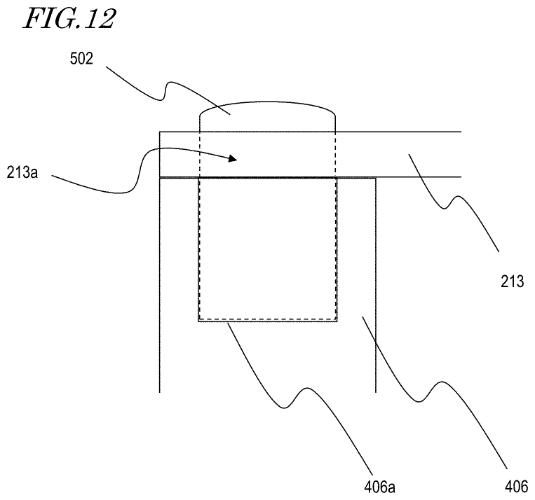

FIG. 11A is a diagram for describing a method of determining an alignment hole(s) by using a knock pin(s). The following description illustrates an example in which a first hole and a second hole are made respectively in the inner cover 213 and the wall 406, and a knock pin extends through the first hole into the second hole to achieve alignment. FIG. 12 is a cross-sectional view showing a straight-shaped knock pin 502 inserted in a first hole 213a in the inner cover 213 and a second hole 406a in the wall 406. In one example, such a knock pin 502 is used to determine the position of the inner cover 213 relative to the first case 211, as is described below.

In FIG. 11A, the position of the center of rotation of the pedal crank shaft 22 is denoted as “P”, and the center of rotation of the transmission shaft 241 denoted as “Q”. The same is also true of FIGS. 11B and 11C to be referred below.

The inventors of preferred embodiments of the present invention have considered where to place the first hole R, to find that the first hole R may advantageously be provided (i) on a straight line L2 perpendicular to a line segment L1 connecting positions P and Q, and (ii) at a position on the outer peripheral edge 462 of the inner cover 213.

In order to position the pedal crank shaft 22 and the transmission shaft 241 with a necessary precision, it is required that a misalignment between position P and position Q of centers of rotation of the respective shafts will manifest itself so that an alignment by using the alignment holes is not possible. Stated otherwise, an alignment by using the alignment holes being possible means that there must be zero misalignment, or not more than a tolerable misalignment, between position P and position Q of centers of rotation of the respective shafts. Now, on any position on the above-described straight line L2, some distance from position P and position Q can be provided. The farther away from the intersection between the straight line L1 and the straight line L2 the position on the straight line L2 is chosen, the more likely it is that any misalignment between position P and position Q will manifest itself, which is why (i) a position on the straight line L2 is used. In order to maintain the distances from position P and position Q to be equal to each other, a point on a straight line L2 that passes through a midpoint on the line segment L1 may be used.

On the other hand, the reason why (ii) a position on the outer peripheral edge 462 is used is so that an alignment of the inner cover 213 relative to the first case 211 is achieved, or more specifically, so that the inner cover 213 is able to support the transmission shaft 241 with a high precision.

Alignment structures may be provided in two places. In the case where the above-described spigot joint structure is also provided, however, an alignment structure using a knock pin may be provided only in one place.

In the present preferred embodiment, the inner cover 213 has a circular or substantially circular shape, and the above-described spigot joint structure is used for the inner cover 213 and the inner wall 406. This leaves the inner cover 213 only a freedom as to the rotation direction. Therefore, a position on the outer peripheral edge 462 that is the farthest from the center position is used for alignment. By using the spigot joint structure to achieve alignment between the inner cover 213 and the wall 406, and further using the knock pin to achieve alignment concerning the relative angle of rotation between the inner cover 213 and the wall 406, the alignment of the transmission shaft 241 as supported by the inner cover 213 is also easily achieved.

As for the second hole, the second hole may be provided at a position on the wall 406 facing the position of the first hole when the inner cover 213 is installed in the proper position.

Thus, by performing an alignment with a first hole located at a position which is on the outer peripheral edge 462 of the inner cover 213 and which is distant from the transmission shaft 241 and the pedal crank shaft 22, it becomes possible to smoothly align the transmission shaft 241 and the pedal crank shaft 22 so as to be placed in their respectively expected positions. Since the inter-shaft distance between the transmission shaft 241 and the pedal crank shaft 22 is kept within a margin of error as designed, a smooth power transmission is achieved.

In FIG. 11A, a position of the first hole R that is determined by the above method is shown. FIG. 11A also shows an example of a first hole Ra located in another position. This first hole Ra is provided on a straight line L2a that is perpendicular or substantially perpendicular to the line segment L1 and at a position on the outer peripheral edge 462 of the inner cover 213.

In a different example from the above example, a position chosen solely on the basis of condition (ii) above (i.e., on the outer peripheral edge 462 of the inner cover 213) may be used as the position of the alignment hole. FIG. 11B shows the positions of the first hole(s) R and/or Ra located on the outer peripheral edge 462. A position that is chosen solely on the basis of condition (ii) is inclusive of any position that also satisfies condition (i), and is meant to enable a broader range of selection of the first hole position.

The inventors of preferred embodiments of the present invention have also sought other methods for locating the first hole that can provide for a more accurate alignment. FIG. 11C is a diagram for describing another position that can be used as the position of an alignment hole. In FIG. 11C, a hole Rb is used as an alignment hole. Specifically, the first hole Rb is located at a position which is on the outer peripheral edge 462 and at which an angle θ between the above-described line segment PQ and the tangent L3 from the position P to the outer peripheral edge 462 is closest to 90 degrees. In the example shown in FIG. 11C, a tangent could also extend from position P to the outer peripheral edge 462, with a point of tangency near the hole R shown in FIGS. 11A and 11B. However, based on the above-described condition concerning the angle, the position indicated as “Rb” is chosen as the position of the first hole.

In the case in which a spigot joint structure is not provided, alignment structures using a knock pin may be provided in two places. In that case, the distance between the alignment structures in two places should preferably be as long as possible. The alignment between the transmission shaft 241 and the pedal crank shaft 22 is also smoothly achieved in the case in which alignment structures using a knock pin are provided in two places, such that effects similar to the above are obtained.

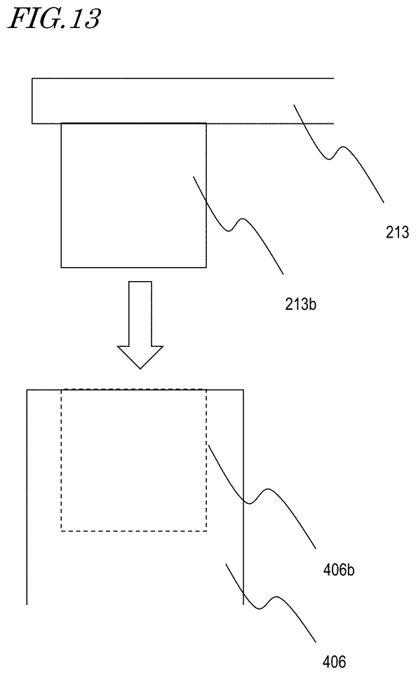

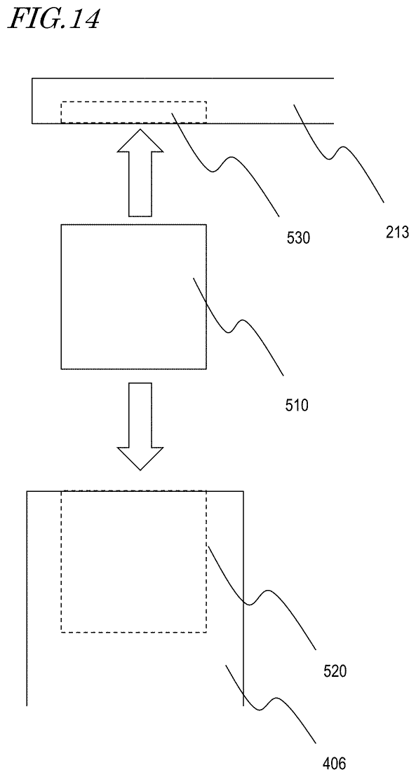

Next, with reference to FIG. 13 and FIG. 14, variations of alignment structures using a knock pin will be described.

FIG. 13 shows a first variation of an alignment structure using a knock pin. The inner cover 213 includes a protrusion 213b. The protrusion 213b functions as a knock pin which goes into a hole or recess 406b in the wall 406, thus achieving alignment between the inner cover 213 and the wall 406. The position at which to provide the protrusion 213b can be determined by the method described with reference to FIG. 9. In this variation, there is no need to make a through hole in the inner cover 213. There is no need to make a through hole in the wall 406, either.

FIG. 13 illustrates that the inner cover 213 has the protrusion 213b, while the wall 406 or the first case 211 has the recess 406b. However, it may be the inner cover 213 that has the recess, and the wall 406 or the first case 211 may have the protrusion.

FIG. 14 shows a second variation of an alignment structure using a knock pin. A recess 530 is provided in the inner cover 213. As the knock pin 510 fits into the recess 530, and also into a recess 520 in the wall 406, alignment between the inner cover 213 and the wall 406 is achieved. In this variation, there is no need to make through holes in the inner cover 213 and the wall 406.

The above-described knock pin and protrusion 213b functioning as a knock pin may have any arbitrary shape. The protrusion 213b may typically be straight-shaped. However, one end of the protrusion 213b may be tapered. The knock pin 502 shown in FIG. 12 may also be tapered.

Thus, illustrative preferred embodiments of the present invention have been described above. However, the present invention is not to be limited to the above-described preferred embodiments. For example, although the above-described preferred embodiments illustrate an electrically assisted bicycle including a suspension, preferred embodiments of the present invention can also be suitably used for an electrically assisted bicycle that lacks suspensions.

Although the above-described preferred embodiments illustrate a drive unit of a type in which a human force and an assistance force of the electric motor 25 are merged at an element that rotates coaxially with the pedal crank shaft 22 (merge-at-crank type), preferred embodiments of the present invention are not limited thereto. Preferred embodiments of the present invention are also suitably applicable to drive units of a type in which a human force and an assistance force are merged by a chain (merge-at-chain type). In the case of a merge-at-chain type, the outer member 52 does not have a gear 2333 to receive the assisting driving power from the electric motor 25.

Thus, illustrative preferred embodiments of the present invention have been described above.

A drive unit according to a preferred embodiment of the present invention is mountable to a body frame 12 of an electrically assisted bicycle 10 to generate a driving power which is transmitted to a wheel 14R of the electrically assisted bicycle. The drive unit 20 includes a housing 21; an electric motor 25 accommodated in the housing 21; a pedal crank shaft 22 extending through the housing 21 along a right-left direction of the electrically assisted bicycle 10 and being rotatably supported by the housing 21; a tubular connecting shaft 231 through which the pedal crank shaft 22 extends and which transmits a pedaling force from a first end 231L to a second end 231R thereof, the first end 231L being coupled to the pedal crank shaft 22; a one-way clutch 50 to transmit the pedaling force having been transmitted to the second end 231R of the connecting shaft 231 to a drive sprocket wheel 34; and a speed reducer 24 including a gear rotary shaft 241 with which the rotation generated by the electric motor 25 is reduced in speed to increase an output torque of the electric motor 25. The housing 21 includes a first case 211 including a first aperture 402 through which one end of the pedal crank shaft 22 extends and a recess 404 in which the electric motor 25 is accommodated; a second case 212 including a second aperture through which another end of the pedal crank shaft 22 extends, the second case 212 and the first case 211 together defining an exterior of the housing 21; and an inner cover 213 that covers at least a portion of the electric motor 25d accommodated in the recess 404 of the first case 211, the inner cover 213 including a third aperture 440 through which an output shaft 2522 of the electric motor 25 extends. The inner cover 213 rotatably supports the gear rotary shaft 241 of the speed reducer 24, and a portion 460 of an outer peripheral edge 462 of the inner cover 213 extends between the gear rotary shaft 241 and the pedal crank shaft 22. The recess 404 of the first case 211 includes a wall 406 extending around a periphery of the electric motor 25, and the wall 406 supports the inner cover 213. The inner cover 213 is supported by the wall 406 of the recess 404, which is highly rigid, such that misalignment of the inner cover 213 is significantly reduced or prevented. This significantly reduces or prevents misalignment of the gear rotary shaft 241 of the speed reducer 24 supported by the inner cover 213.

In a preferred embodiment of the present invention, between the recess 404 and the first aperture 402, the first case 211 may include a slope 408a extending from the first aperture 402 to the wall 406. The first case 211 including the slope 408a corresponding to the wall 406 enables the rigidity of the wall 406 to be enhanced.

In a preferred embodiment of the present invention, the first case 211 includes a second recess 408 including the first aperture 402 at a bottom thereof. The slope 408a may define a portion of the second recess 408. Because the wall 406 of the recess 404 accommodating the electric motor 25 is connected to the second recess 408, the rigidity of the wall 406 of the recess 404 accommodating the electric motor 25 is enhanced.

In a preferred embodiment of the present invention, when the inner cover 213 is viewed in a direction parallel to the output shaft 2522 of the electric motor 25, the outer peripheral edge 462 of the inner cover 213 may extend around the periphery of the electric motor 25. The inner cover 213 does not extend over to the pedal crank shaft 22 and has a small-size, such that the rigidity of the inner cover 213 is enhanced. Since the inner cover 213 has a high rigidity, misalignment of the gear rotary shaft 241 of the speed reducer 24 supported by the inner cover 213 is significantly reduced or prevented.

In a preferred embodiment of the present invention, the outer peripheral edge 462 of the inner cover 213 may be fixed to the wall 406 at a plurality of positions. Because the inner cover 213 is fixed to the wall 406 at a plurality of positions, flexure of the inner cover 213 is significantly reduced or prevented.

In a preferred embodiment of the present invention, the inner cover 213 may rotatably support the output shaft 2522 of the electric motor 25. The inner cover 213 supports the gear rotary shaft 241 of the speed reducer 24 and the output shaft 2522 of the electric motor 25. Because both of the gear rotary shaft 241 of the speed reducer 24 and the output shaft 2522 of the electric motor 25 are supported by a single element, misalignment between the gear rotary shaft 241 of the speed reducer 24 and the output shaft 2522 of the electric motor 25 is significantly reduced or prevented.

In a preferred embodiment of the present invention, the drive unit 20 may further include an alignment structure to determine relative positioning between the inner cover 213 and the first case 211. By aligning the inner cover 213 and the first case 211, alignment between the gear rotary shaft 241 of the speed reducer 24 and the pedal crank shaft 22 is achieved, thus realizing a smooth power transmission.

In a preferred embodiment of the present invention, the inner cover 213 may include a protrusion 213b or a recess to determine a position of the inner cover 213 relative to the first case 211, the first case 211 including a recess 406b or protrusion to engage with the protrusion 213b or the recess. By aligning the inner cover 213 and the first case 211 through engagement of the protrusion and the recess, a more accurate alignment between the gear rotary shaft 241 of the speed reducer 24 and the pedal crank shaft 22 is achieved, such that a smooth power transmission is achieved.

In a preferred embodiment of the present invention, the inner cover 213 may include a first hole 213a, and the first case 211 may include a second hole 406a; and a knock pin 502 may extend through the first hole 213a into the second hole 406a. By aligning the inner cover 213 and the first case 211 with use of the knock pin 502, a more accurate alignment between the gear rotary shaft 241 of the speed reducer 24 and the pedal crank shaft 22 is achieved, such that a smooth power transmission is achieved.

In a preferred embodiment of the present invention, the inner cover 213 and the wall 406 may include a spigot joint structure 500 in which the inner cover 213 fits into the wall 406. By aligning the inner cover 213 and the first case 211 via the spigot joint structure (mate fitting) 500, alignment between the gear rotary shaft 241 of the speed reducer 24 and the pedal crank shaft 22 is achieved, such that a smooth power transmission is achieved.

In a preferred embodiment of the present invention, the inner cover 213 and the wall 406 include a spigot joint structure 500 in which the inner cover 213 is able to rotate relative to the wall 406. The inner cover 213 includes a first hole 213a, and the first case 211 includes a second hole 406a. A knock pin 502 extends through the first hole 213a into the second hole 406a. The first hole 213a (first hole R) may be located at a position that is on a straight line L2 that is perpendicular to a line segment L1 connecting the pedal crank shaft 22 and the gear rotary shaft 241 of the speed reducer 24, and on the outer peripheral edge 462. By providing the first hole 213a (first hole R) at a position which is on the outer peripheral edge 462 and which is distant from the gear rotary shaft 241, even if an offset occurs during an alignment process using the knock pin 502, the misalignment of the gear rotary shaft 241 associated therewith is reduced.

In a preferred embodiment of the present invention, the inner cover 213 and the wall 406 include a spigot joint structure in which the inner cover 213 is able to rotate relative to the wall 406. The inner cover 213 includes a first hole 213a, and the first case 211 includes a second hole 406a. A knock pin 502 extends through the first hole 213a into the second hole 406a. The first hole 213a (first hole Rb) may be located at a position on the outer peripheral edge 462 and at which an angle θ between a line segment L1 connecting the pedal crank shaft 22 and the gear rotary shaft 241 of the speed reducer 24 and a tangent L3 from the pedal crank shaft 22 to the outer peripheral edge 462 is closest to 90 degrees. By providing the first hole 213a (first hole Rb) at a position which is on the outer peripheral edge 462 and which is distant from the gear rotary shaft 241, even if an offset occurs during an alignment process using the knock pin 502, the misalignment of the gear rotary shaft 241 associated therewith is reduced.

In a preferred embodiment of the present invention, the drive unit 20 further includes a circuit board 48 on which a drive circuit to drive the electric motor 25 is mounted. The inner cover 213 includes a first surface and a second surface. The first surface faces the electric motor 25, and the second surface is opposite to the first surface. Within the housing 21, the circuit board 48 may be located in a space that is on a side of the second surface of the inner cover 213. The circuit board 48 is located at a position distinct from the recess 404 accommodating the electric motor 25. This enables the recess 404 to be small, thus enhancing the rigidity of the wall 406 of the recess 404.

In a preferred embodiment of the present invention, the inner cover 213 may be surrounded by the first case 211 and the second case 212 without being exposed outside the drive unit 20. Because the inner cover 213 is not exposed to the outside, the parts of the housing 21 that need painting are reduced to two, i.e., the first case 211 and the second case 212. Moreover, the parts of the housing 21 for which waterproof sealant needs to be applied are reduced to two, i.e., the first case 211 and the second case 212. Thus, the production costs are reduced.

In a preferred embodiment of the present invention, the inner cover 213 may be enclosed by the first case 211 and the second case 212. Because the inner cover 213 is enclosed without being exposed to the outside, the parts of the housing 21 that need painting are reduced to two, i.e., the first case 211 and the second case 212. Moreover, the parts of the housing for which waterproof sealant needs to be applied are reduced to two, i.e., the first case 211 and the second case 212. Thus, the production costs are reduced.

An electrically assisted bicycle according to a preferred embodiment of the present invention includes a drive unit 20 according to any of the above preferred embodiments. Because the gear rotary shaft 241 of the speed reducer 24 is supported by the inner cover 213, an electrically assisted bicycle 10 is achieved in which misalignment of the gear rotary shaft 241 in the drive unit 20 a misalignment of the gear rotary shaft 241 is significantly reduced or prevented.

Preferred embodiments of the present invention are particularly useful in the fields of electrically assisted bicycle and drive units mountable to the electrically assisted bicycles.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A drive unit mountable to a body frame of an electrically assisted bicycle to generate a driving power which is transmitted to a wheel of the electrically assisted bicycle, the drive unit comprising:
a housing;
an electric motor accommodated in the housing;
a pedal crank shaft extending through the housing along a right-left direction of the electrically assisted bicycle and rotatably supported by the housing;
a connecting shaft through which the pedal crank shaft extends to transmit a pedaling force from a first end to a second end thereof, the first end being coupled to the pedal crank shaft;
a one-way clutch to transmit the pedaling force from the second end of the connecting shaft to a drive sprocket wheel; and
a speed reducer including a gear rotary shaft to reduce a rotation speed generated by the electric motor and increase an output torque of the electric motor; wherein
the housing includes:
a first case including a first aperture through which a first end of the pedal crank shaft extends and a recess in which the electric motor is accommodated;
a second case including a second aperture through which a second end of the pedal crank shaft extends, and the second case and the first case together define an exterior of the housing; and
an inner cover that covers at least a portion of the electric motor accommodated in the recess of the first case, and the inner cover includes a third aperture through which an output shaft of the electric motor extends;
the inner cover rotatably supports the gear rotary shaft of the speed reducer, and an outer peripheral edge of the inner cover extends between the gear rotary shaft and the pedal crank shaft; and
the recess of the first case includes a wall extending around a periphery of the electric motor, and the wall supports the inner cover.

2. The drive unit of claim 1, wherein, between the recess and the first aperture, the first case includes a slope extending from the first aperture to the wall.

3. The drive unit of claim 2, wherein
the first case includes a second recess having the first aperture at a bottom thereof; and
the slope defines a portion of the second recess.

4. The drive unit of claim 1, wherein, when the inner cover is viewed in a direction parallel to the output shaft of the electric motor, the outer peripheral edge of the inner cover extends around the periphery of the electric motor.

5. The drive unit of claim 1, wherein the outer peripheral edge of the inner cover is fixed to the wall at a plurality of positions.

6. The drive unit of claim 1, wherein the inner cover rotatably supports the output shaft of the electric motor.

7. The drive unit of claim 1, further comprising an alignment structure to determine a relative position between the inner cover and the first case.

8. The drive unit of claim 1, wherein the inner cover includes a protrusion or a recess to determine a position of the inner cover relative to the first case, and the first case includes a recess or a protrusion to engage with the protrusion or the recess of the inner cover.

9. The drive unit of claim 1, wherein
the inner cover includes a first hole, and the first case includes a second hole; and
a knock pin extends through the first hole into the second hole.

10. The drive unit of claim 1, wherein the inner cover and the wall include a spigot joint structure in which the inner cover fits into the wall.

11. The drive unit of claim 1, wherein
the inner cover and the wall include a spigot joint structure in which the inner cover is able to rotate relative to the wall;
the inner cover includes a first hole, and the first case includes a second hole;
a knock pin extends through the first hole into the second hole; and
the first hole is located at a position on a straight line perpendicular to a line segment connecting the pedal crank shaft and the gear rotary shaft of the speed reducer and on the outer peripheral edge.

12. The drive unit of claim 1, wherein
the inner cover and the wall include a spigot joint structure in which the inner cover is able to rotate relative to the wall;
the inner cover includes a first hole, and the first case includes a second hole;
a knock pin extends through the first hole into the second hole; and
the first hole is located at a position on the outer peripheral edge and at which an angle between a line segment connecting the pedal crank shaft and the gear rotary shaft of the speed reducer and a tangent from the pedal crank shaft to the outer peripheral edge is closest to 90 degrees.

13. The drive unit of claim 1, further comprising:
a circuit board on which a drive circuit to drive the electric motor is mounted; wherein
the inner cover includes a first surface and a second surface;
the first surface faces the electric motor, and the second surface is opposite to the first surface; and
within the housing, the circuit board is located in a space on a side of the second surface of the inner cover.

14. The drive unit of claim 1, wherein the inner cover is surrounded by the first case and the second case, and is not exposed outside the drive unit.

15. The drive unit of claim 1, wherein the inner cover is enclosed by the first case and the second case.

16. An electrically assisted bicycle comprising:
the drive unit of claim 1.
